(19) United States
(12) Patent Application Publication
(10) Pub. No.: US 2013/0146727 A1
(43) Pub. Date: Jun. 13, 2013

(54) Three-Stage Display Panel Mount

(71) Applicant: Steven Oh, Tacoma, WA (US)

(72) Inventor: Steven Oh, Tacoma, WA (US)

(21) Appl. No.: 13/710,447

(22) Filed: Dec. 10, 2012

Related U.S. Application Data
(60) Provisional application No. 61/568,516, filed on Dec. 8, 2011.

(51) Int. Cl. F16M 13/02

(52) U.S. Cl. CPC F16M 13/02
USPC 248/277.1

(57) ABSTRACT

A three-stage display panel mount is an apparatus used to mount a display screen on a vertical wall, but the apparatus allows a user extend the display screen from vertical wall and rotate the display screen to be perpendicular to the vertical wall. The three-stage display panel includes a first-stage frame, a pair to scissor mechanisms, a pair of gas-spring struts, a second-stage frame, and a third-stage frame. The first-stage frame mounts the apparatus on the vertical wall. The pair of scissor mechanisms allows the second-stage frame to extend away from the first-stage frame, and the pair of gas-spring struts stabilizes the movement of the second-stage frame. The third-stage frame can rotate the display panel away from the second-stage frame and includes a pair of collapsible angles, which can either position the display panel parallel to the vertical wall or support the display panel perpendicular to the vertical wall.

The current application is a non-provisional application and claims a priority to the U.S. provisional patent application Ser. No. 61/568,516 filed on Nov. 8, 2011. The current application is filed on Nov. 10, 2012 while Nov. 8, 2012 was on a weekend.

### FIELD OF THE INVENTION

The present invention relates generally to a mounting system for display screens. More specifically, the present invention allows each display screen to be translated and rotated away from its mounting wall so that an audiovisual engineer can access the back of each display panel.

### BACKGROUND OF THE INVENTION

A mounting system provides a device on which a monitor or a display screen can be mounted on a surface perpendicular to a horizontal floor. This feature allows for the display screen to be removed from the traditional floor entertainment setup, thereby freeing up valuable floor space and also providing a less-cluttered atmosphere.

Existing mounting systems allow for the screen position to be manipulated to various positions. However, many of these systems have limitations that limit the movement of the display screen to a forward, backward, or sideways motion. This often provides complications when other entertainment systems require connection to outlets on the back of the display screen. There is a need for a mount that can secure a display screen while providing easy access to the backside of the display screen.

The present invention provides an apparatus for which display screens can be secured and rotated in various directions and angles. The present invention will be configured and scaled to fit monitors of all sizes. The three-way system is not limited to the three positions and can be custom configured to the customer's needs. The three way configuration allows the audiovisual engineer easy access to cables for configurations on the back of the monitor.

### BRIEF DESCRIPTION OF THE DRAWINGS

FIG. 1 is a perspective view of the present invention, wherein the second-stage frame is extended from the first-stage frame and the third-stage frame is rotated away from the second-stage frame.

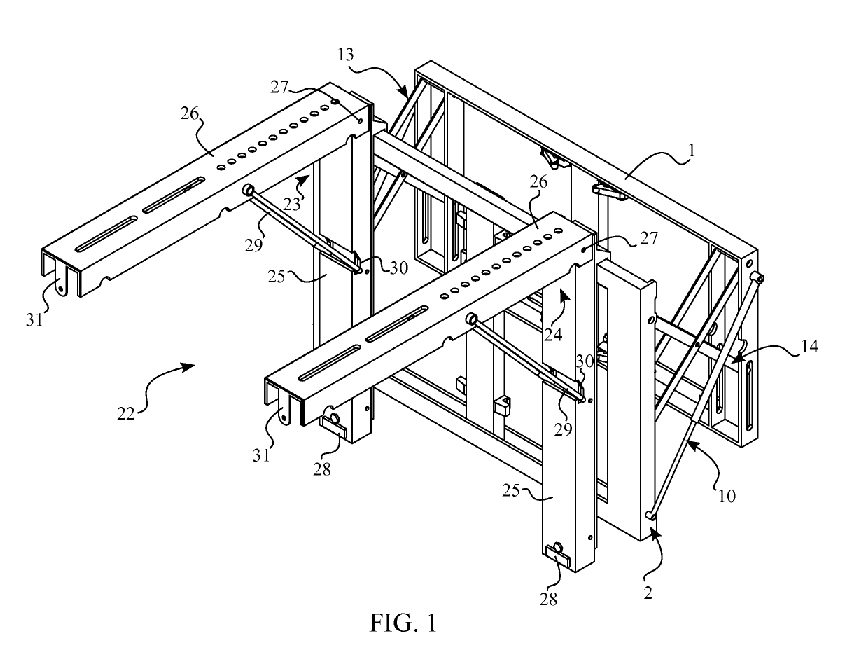

FIG. 2 is a perspective view of the present invention, wherein the second-stage frame is extended from the first-stage frame and the third-stage frame is not rotated away from the second-stage frame.

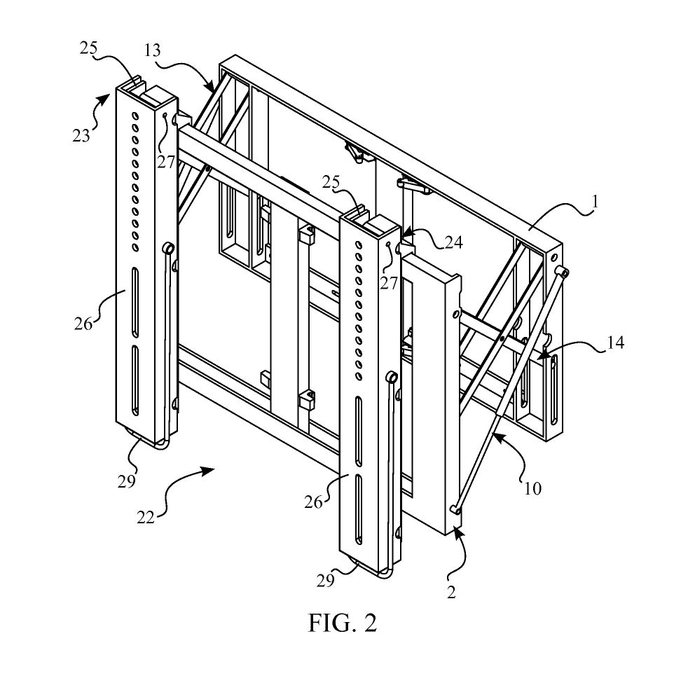

FIG. 3 is a perspective view of the present invention, wherein the second-stage frame is retracted towards the first-stage frame and the third-stage frame is not rotated away from the second-stage frame.

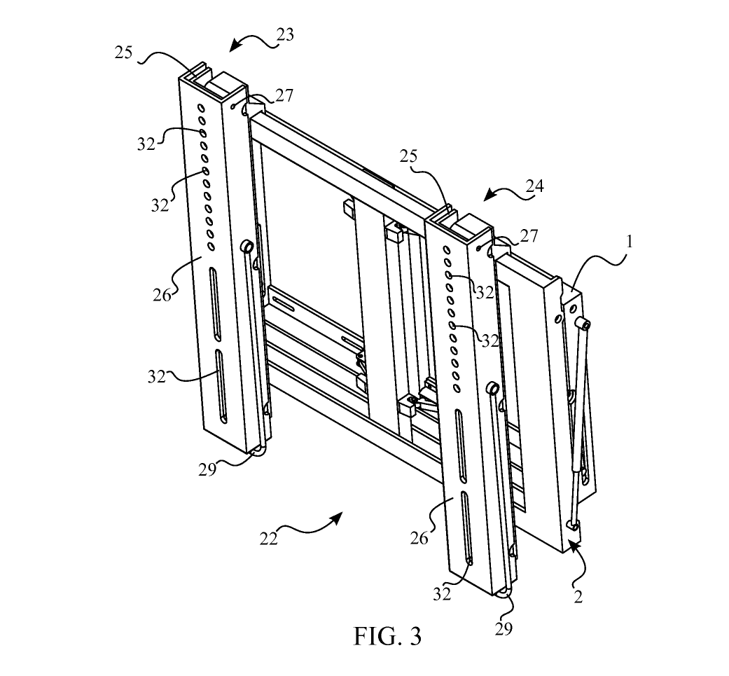

FIG. 4 is a perspective view of the present invention without the third-stage frame, wherein the second-stage frame is retracted towards the first-stage frame.

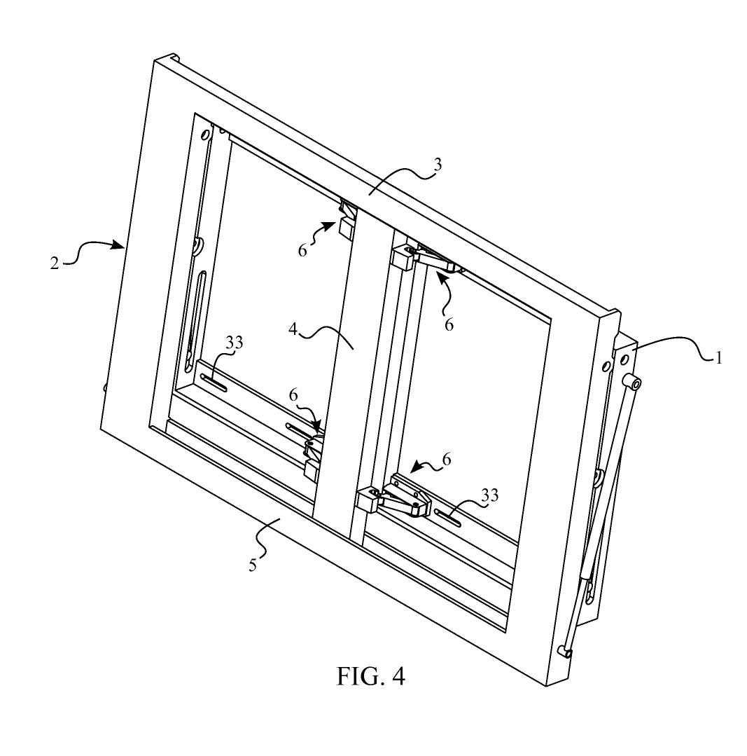

FIG. 5 is a perspective view of the present invention without the third-stage frame, wherein the second-stage frame is extending away from the first-stage frame.

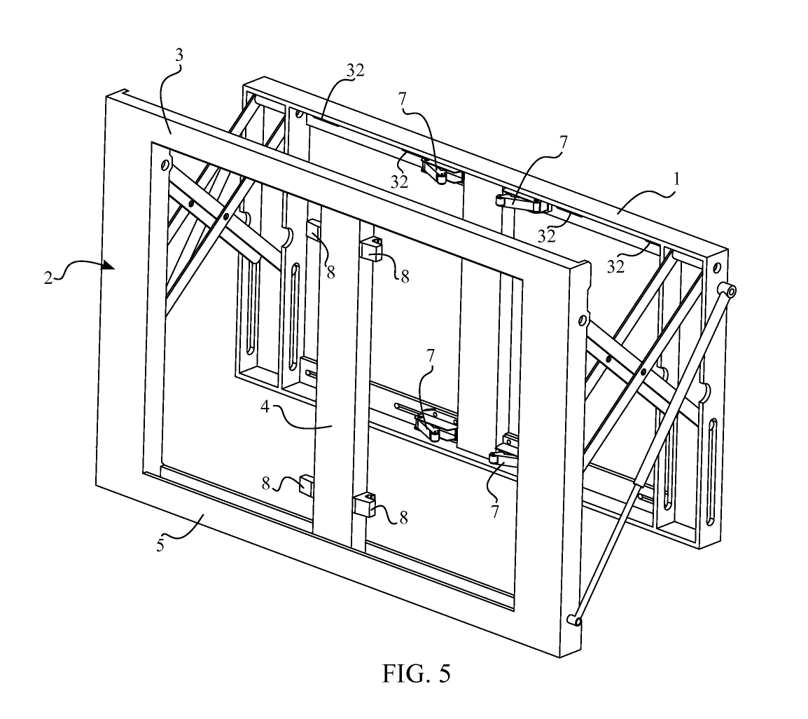

FIG. 6 is a side view of the present invention, wherein the second-stage frame is extended from the first-stage frame and the third-stage frame is rotated away from the second-stage frame.

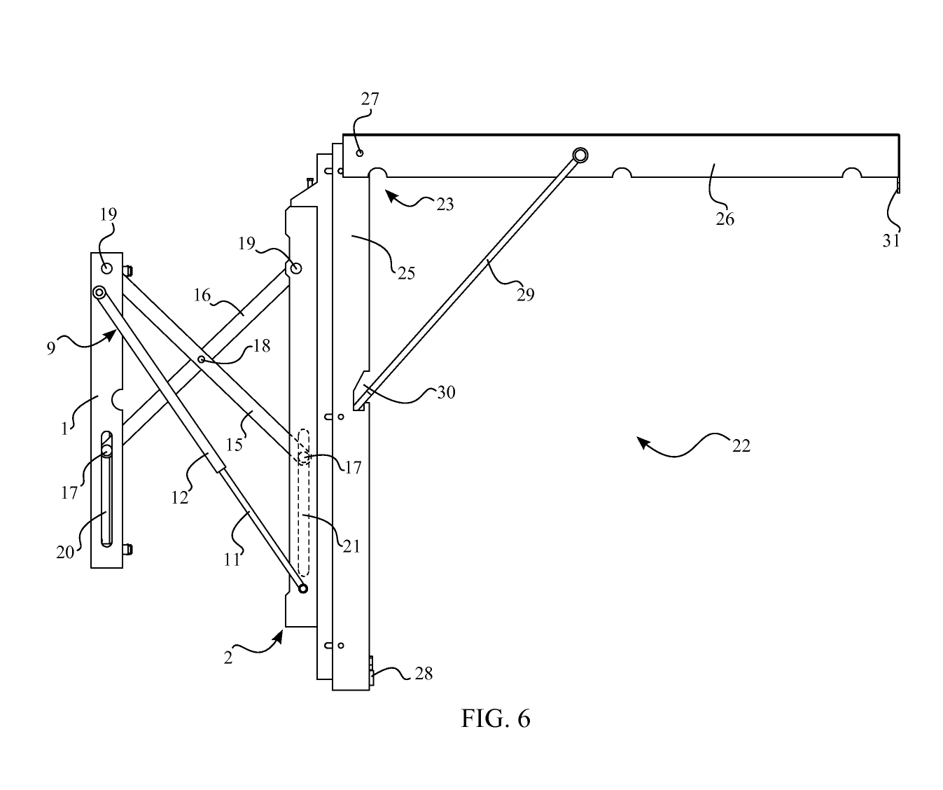

FIG. 7 is a side view of the present invention, wherein the second-stage frame is extended from the first-stage frame and the third-stage frame is not rotated away from the second-stage frame.

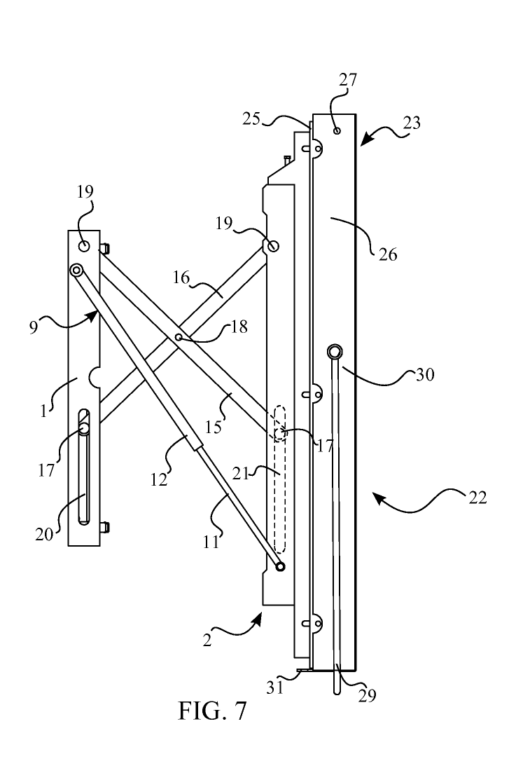

FIG. 8 is a side view of the present invention, wherein the second-stage frame is retracted towards the first-stage frame and the third-stage frame is not rotated away from the second-stage frame.

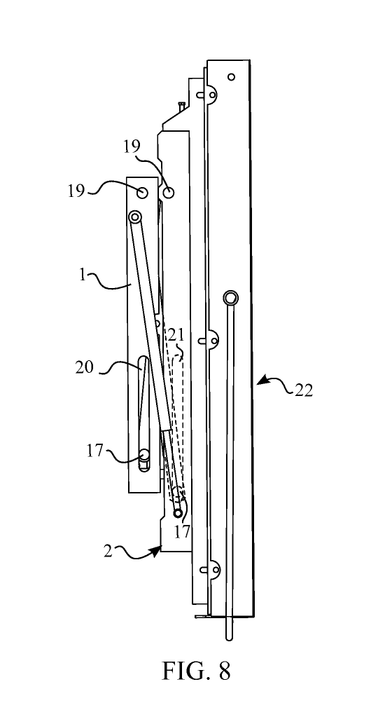

### DETAIL DESCRIPTIONS OF THE INVENTION

All illustrations of the drawings are for the purpose of describing selected versions of the present invention and are not intended to limit the scope of the present invention.

The present invention is a three-stage display panel mount, which is used to extend and to rotate a display panel away from a wall. The present invention allows an audiovisual engineer to access the corresponding wires that are connected to the display panel. The display panel can be a liquid crystal display (LCD), a plasma display panel (PDP), or a light emitting diode (LED) display. The present invention mainly comprises a first-stage frame 1, a second-stage frame 2, a plurality of one-touch-actuated latches 6, a left gas-spring strut 9, a right gas-spring strut 10, an at least one left scissor mechanism 13, an at least one right scissor mechanism 14, a third-stage frame 22, a plurality of panel holes 32, and a plurality of wall holes 33. The first-stage frame 1 is used to mount the present invention with display screen onto a vertical wall. The second-stage frame 2 is used to support and extend the display panel away from the vertical wall. The at least one left scissor mechanism 13 and the at least one right scissor mechanism 14 facilitates the movement between the first-stage frame 1 and the second-stage frame 2, which allows a user to pull the display panel away from the vertical wall. The left gas-spring strut 9 and the right gas-spring strut 10 are used to stabilize the movement between the first-stage frame 1 and the second-stage frame 2 and are used to hold the present invention in the extended position once the second-stage frame 2 is fully separated from the first-stage frame 1. Likewise, the plurality of one-touch-actuated latches 6 is used to hold the present invention in the retracted position when the second-stage frame 2 is pressed against the first-stage frame 1. The third-stage frame 22 is used to rotate the display panel from being parallel to the vertical wall to being perpendicular to the vertical wall. The plurality of wall holes 33 is positioned on the first-stage frame 1 so that the present invention can be mounted to the wall. The plurality of panel holes 32 is positioned on the third-stage frame 22 so that the display panel can be mounted to the present invention.

The configuration of the first-stage frame 1, the second-stage frame 2, the left gas-spring strut 9, the right gas-spring strut 10, the at least one left scissor mechanism 13, and the at least one right scissor mechanism 14 allows the present invention to efficiently move from the retracted position to the extended position and to efficiently move from the extended position to the retracted position. The first-stage frame 1 and the second-stage are both an arrangement of structural members such as pipes or rods. The first-stage frame 1 and the second-stage frame 2 each comprise a top section 3, a longitudinal section 4, and a bottom section 5. For both the first-stage frame 1 and the second-stage frame 2, the top section 3 is positioned parallel to the bottom section 5, and the longitudinal section 4 is positioned perpendicular to the top section 3 and to the bottom section 5. The longitudinal section 4 of the first-stage frame 1 and the longitudinal section 4 of the second-stage frame 2 are aligned with each other so that the plurality of one-touch-actuated latches 6 can keep the present invention in the retracted position. Each of the plurality of one-touch-actuated latches 6 comprises a male portion 7 and a female portion 8. The male portion 7 of each of the plurality of one-touch-actuated latches 6 is positioned along the longitudinal section 4 of the first-stage frame 1. The female portion 8 of each of the plurality of one-touch-actuated latches 6 is positioned along the longitudinal section 4 of the second-stage frame 2. In order for the male portion 7 to engage the female portion 8, the female portion 8 of each of the plurality of one-touch-actuated 6 latches should be aligned to their corresponding male portion 7. The plurality of one-touch-actuated latches 6 allows the present invention to easily lock into the retracted position and to easily unlock from the retracted position.

The at least one left scissor mechanism 13 and the at least one right scissor mechanism 14 allow the second-stage frame 2 to extend away from the first-stage frame 1 in a controlled motion, which requires both the at least one left scissor mechanism 13 and the at least one right scissor mechanism 14 to be positioned in between the first-stage frame 1 and the second-stage frame 2. The at least one left scissor mechanism 13 and the at least one right scissor mechanism 14 are positioned opposite each other in order to uniformly brace the second-stage frame 2 while the second-stage frame 2 is extending away from the first-stage frame 1. Furthermore, the at least one left scissor mechanism 13 and the at least one right scissor mechanism 14 each comprise a first rod 15, a second rod 16, a first longitudinal track 20, and a second longitudinal track 21. The first rod 15 and the second rod 16 are the primary components in each of the scissor mechanisms. The first rod 15 and the second rod 16 each comprise a translational pivot point 17, a central pivot point 18, and a fixed pivot point 19, which allow each of scissor mechanisms to perform an extension motion and a contractive motion. For both the first rod 15 and the second rod 16, the fixed pivot point 19 and the translational pivot point 17 are positioned opposite each other along the length of the rod. The central pivot point 18 is also positioned in between the fixed pivot point 19 and the translational pivot point 17. Consequently, the central pivot point 18 of the first rod 15 is rotatably connected to the central pivot point 18 of the second rod 16, which creates a range of motion between the first rod 15 and the second rod 16 that facilitates the extension motion and the contractive motion of each of the scissor mechanisms.

The first rod 15 and the second rod 16 must be connected or situated in specific areas in order to further enable the extension motion and the contractive motion of each of the scissor mechanisms. The fixed pivot point 19 of the first rod 15 is rotatably connected to the top section 3 of the first-stage frame 1, and the fixed pivot point 19 of the second rod 16 is rotatably connected to the top section 3 of the second-stage frame 2. Consequently, the top of both the first rod 15 and the second rod 16 stay situated while the second-stage frame 2 extends away from the first-stage frame 1. In addition, the first longitudinal track 20 is positioned adjacent to the bottom section 5 of the first-stage frame 1, and the second longitudinal track 21 is positioned adjacent to the bottom section 5 of the second-stage frame 2. The translational pivot point 17 of the first rod 15 is engaged to the second longitudinal track 21, which allows the translational pivot point 17 of the first rod 15 to rotate within the second longitudinal track 21 and to translate along the second longitudinal track 21. Likewise, the translational pivot point 17 of the second rod 16 is engaged to the first longitudinal track 20, which allows the translation pivot point of the second rod 16 to rotate within the first longitudinal track 20 and to translate along the first longitudinal track 20. Consequently, the bottom of both the first rod 15 and the second rod 16 translates up while the second-stage frame 2 extends away from the first-stage frame 1 and translates down while the second-stage frame 2 retracts toward the first-stage frame 1.

The left gas-spring strut 9 and the right gas-spring strut 10 are used to stabilize the extension motion and the contractive motion of each of the scissor mechanisms. In order to stabilize the movement of the first-stage frame 1 and the second-stage frame 2, the left gas-spring strut 9 is positioned adjacent to the at least one left scissor mechanism 13 opposite to the at least one right scissor mechanism 14. In addition, the right gas-spring strut 10 is positioned adjacent to the at least one right scissor mechanism 14 opposite to the at least one left scissor mechanism 13. This configuration allows the left gas-spring strut 9 and the right gas-spring strut 10 to brace both sides of the first-stage frame 1 and the second-stage frame 2 so that the left gas-spring strut 9 and the right gas-spring strut 10 can uniformly stabilize the first-stage frame 1 and the second-stage frame 2 during the extension motion and the contractive motion of each of the scissor mechanisms. The left gas-spring strut 9 and the right gas-spring strut 10 each comprise a piston end 11 and a cylinder end 12. For both the left gas-spring strut 9 and the right gas-spring strut 10, the piston end 11 and the cylinder end 12 are positioned opposite to each other along the length of the strut. For the left gas-spring strut 9, the cylinder end 12 is rotatably connected to the top section 3 of the first-stage frame 1, and the piston end 11 is rotatably connected to the bottom section 5 of the second-stage frame 2. For the right gas-spring strut 10, the cylinder end 12 is rotatably connected to the top section 3 of the first-stage frame 1, and the piston end 11 is rotatably connected to the bottom section 5 of the second-stage frame 2. Thus, the piston end 11 of both the left gas-spring strut 9 and the right gas-spring strut 10 will exert a force on the bottom of the third-stage frame 22 in order to compensate for the weight of display panel when the display panel is rotated away from the second-stage frame 2.

The third-stage frame 22 is used to rotate the display panel so that the display panel is perpendicular to the vertical wall instead of being parallel to the vertical wall, which allows for easier access to the corresponding wires of the display panel. The third-stage frame 22 is positioned adjacent to the second-stage frame 2 opposite to the first-stage frame 1 so that the at least one left scissor mechanism 13 and the at least one right scissor mechanism 14 do not obstruct the third-stage frame 22 while rotating the display panel to be perpendicular to the vertical wall. The third-stage frame 22 comprises a left collapsible angle 23 and a right collapsible angle 24. The left collapsible angle 23 and the right collapsible angle 24 are positioned opposite to each other across the second-stage frame 2, which allows the left collapsible angle 23 and the right collapsible angle 24 to uniformly stabilize the display panel. The left collapsible angle 23 and the right collapsible angle 24 each comprise a bar-shaped leg 25, a channel-shaped leg 26, a hinge 27, a stopper 28, a hanging prop 29, a notch 30, and a securing tab 31. The bar-shaped leg 25 allows the third-stage frame 22 to be connected to the second-stage frame 2, and the channel-shaped leg 26 allows the third-stage frame 22 to be attached to the display panel. The plurality of panel holes 32 is specifically positioned on the channel-shaped leg 26. The bar-shaped leg 25 is rotatably connected to the channel-shaped leg 26 by the hinge 27, which allows the display panel to rotate from being parallel to the vertical wall to being perpendicular to the vertical wall. The stopper 28 is connected perpendicular to the bar-shaped leg 25 and allows the channel-shaped leg 26 to properly rest against the bar-shaped leg 25 so that the display panel will be parallel to the vertical wall. The stopper 28 and the hinge 27 are also positioned opposite to each other along the bar-shaped leg 25. The securing tab 31 is connected perpendicular to the channel-shaped leg 26. The securing tab 31 and the hinge 27 are also positioned opposite to each other, which allows the securing tab 31 to adjacently press against the end of the bar-shaped leg 25 and, thus, stabilizes the channel-shaped leg 26 on the bar-shaped leg 25. The bar-shaped leg 25 will also traverse into the channel-shaped leg 26 in order to properly position the channel-shaped leg 26 parallel to the bar-shaped leg 25.

Once the display panel is rotated to be perpendicular to the vertical wall, the left collapsible angle 23 and the right collapsible angle 24 will respectively need to use their hanging prop 29 and their notch 30 in order to maintain the perpendicular position of the display panel to the vertical wall. The notch 30 is positioned in between the stopper 28 and hinge 27 and traverses into the bar-shaped leg 25. The hanging prop 29 is positioned in between the securing tab 31 and the hinge 27 and is rotatably connected to the channel-shaped leg 26. The hanging prop 29 will engage the notch 30 in order to perpendicularly position the channel-shaped leg 26 to the bar-shaped leg 25. Consequently, the display panel is properly supported by the third-stage frame 22 while the display panel is perpendicular to the vertical wall. When the hanging prop 29 is disengaged from the notch 30, the display panel can be rotated back to being parallel with the vertical wall so that the channel-shaped leg 26 can rest against the stopper 28 and the securing tab 31 can adjacently press against the side of the bar-shaped leg 25.

Although the invention has been explained in relation to its preferred embodiment, it is to be understood that many other possible modifications and variations can be made without departing from the spirit and scope of the invention as hereinafter claimed.

What is claimed is:

1. A three-stage display panel mount comprises,
a first-stage frame;
a second-stage frame;
a plurality of one-touch-actuated latches;
a left gas-spring strut;
a right gas-spring strut;
an at least one left scissor mechanism;
an at least one right scissor mechanism;
a third-stage frame;
a plurality of panel holes;
said first-stage frame comprises a top section, a longitudinal section, and a bottom section;
each of the plurality of one-touch-actuated latches comprises a male portion and a female portion;
said left gas-spring strut and said right gas-spring strut each comprise a piston end and a cylinder end;
said at least one left scissor mechanism and said at least one right scissor mechanism each comprise a first rod, a second rod, a first longitudinal track, and a second longitudinal track;
said third-stage frame comprises a left collapsible angle and a right collapsible angle;
said first rod and said second rod each comprise a translational pivot point, a central pivot point, and a fixed pivot point; and
said left collapsible angle and said right collapsible angle each comprise a bar-shaped leg, a channel-shaped leg, a hinge, a stopper, a hanging prop, and a notch.

2. The three-stage display panel mount as claimed in claim 1 comprises,
said top section being positioned parallel to said bottom section;
said longitudinal section being positioned in between said top section and said bottom section;
said longitudinal section being positioned perpendicular to both said top section and said bottom section;
said longitudinal section of said first-stage frame and said longitudinal section of said second-stage frame being aligned with each other;
both said at least one left scissor mechanism and said at least one right scissor mechanism being positioned in between said first-stage frame and said second-stage frame;
said at least one left scissor mechanism and said at least one right scissor mechanism being positioned opposite to each other;
said left gas-spring strut being positioned adjacent to said at least one left scissor mechanism opposite to said at least one right scissor mechanism; and
said right gas-spring strut being positioned adjacent to said at least one right scissor mechanism opposite to said at least one left scissor mechanism.

3. The three-stage display panel mount as claimed in claim 2 comprises,
said male portion of each of said plurality of one-touch-actuated latches being positioned along said longitudinal section of said first-stage frame;
said female portion of each of said plurality of one-touch-actuated latches being positioned along said longitudinal section of said second-stage frame; and
said female portion of each of the said plurality of one-touch-actuated latches being aligned with said male portion of each of the plurality of one-touch-actuated latches.

4. The three-stage display panel mount as claimed in claim 1 comprises,
said fixed pivot point of said first rod being rotatably connected to said top section of said first-stage frame;
said fixed pivot point of said second rod being rotatably connected to said top section of second-stage frame;
said first longitudinal track being positioned adjacent to said bottom section of said first-stage frame;
said second longitudinal track being positioned adjacent to said bottom section of said second-stage frame;
said translational pivot point of said first rod being engaged to said second longitudinal track;
said translation pivot point of said second rod being engaged to said first longitudinal track; and
said central pivot point of said first rod being rotatably connected to said central pivot point of said second rod.

5. The three-stage display panel mount as claimed in claim 4 comprises,
said fixed pivot point and said translational pivot point for said first rod being positioned opposite each other along said first rod;
said fixed pivot point and said translational pivot point for said second rod being positioned opposite each other along said second rod;
said central pivot point for said first rod being positioned in between said fixed pivot point and said translation pivot point along said first rod; and
said central pivot point for said second rod being positioned in between said fixed pivot point and said translation pivot point along said second rod.

6. The three-stage display panel mount as claimed in claim 1 comprises,
said cylinder end and said piston end for said left gas-spring strut being positioned opposite to each other along said left gas-spring strut;
said cylinder end of said left gas-spring strut being rotatably connected to said top section of said first-stage frame;
said piston end of said left gas-spring strut being rotatably connected to said bottom section of said second-stage frame;
said cylinder end and said piston end for said right gas-spring strut being positioned opposite to each other along said right gas-spring strut;
said cylinder end of said right gas-spring strut being rotatably connected to said top section of said first-stage frame; and
said piston end of said right gas-spring strut being rotatably connected bottom section of said second-stage frame.

7. The three-stage display panel mount as claimed in claim 1 comprises,
said third-stage frame being positioned adjacent to said second-stage frame opposite to said first-stage frame; and
said left collapsible angle and said right collapsible angle being positioned opposite to each other across said second stage frame.

8. The three-stage display panel mount as claimed in claim 1 comprises,
said bar-shaped leg being connected on said second-stage frame;
said bar-shaped leg being pivotally connected to said channel-shaped leg by said hinge;
said stopper being connected perpendicular to said bar-shaped leg;
said stopper and said hinge being positioned opposite to each other along said bar-shaped leg;
said securing tab being connected perpendicular to said channel-shaped leg;
said securing tab and said hinge being positioned opposite to each other along said channel-shaped leg;
said notch being positioned in between said stopper and said hinge and traversing into said bar-shaped leg; and
said hanging prop being rotatably connected to said channel-shaped leg.

9. The three-stage display panel mount as claimed in claim 8 comprises,
said notch being engaged by said hanging prop in order to perpendicularly position said channel-shaped leg to said bar-shaped leg.

10. The three-stage display panel mount as claimed in claim 8 comprises,
said channel-shaped leg being pressed against said stopper in order to position said channel-shaped leg parallel to said bar-shaped leg;
said bar-shaped leg traversing into said channel-shaped leg in order to position said channel-shaped leg parallel to said bar-shaped leg; and
said securing tab being adjacently pressed against said bar-shaped leg in order to position said channel-shaped leg parallel to said bar-shaped leg.

11. The three-stage display panel mount as claimed in claim 1 comprises,
said plurality of wall holes being positioned on said first-stage frame; and
said plurality of panel holes being positioned on both said channel-shaped leg of said left collapsible angle and said channel-shaped leg of said right collapsible angle.

12. A three-stage display panel mount comprises,
a first-stage frame;
a second-stage frame;
a plurality of one-touch-actuated latches;
a left gas-spring strut;
a right gas-spring strut;
an at least one left scissor mechanism;
an at least one right scissor mechanism;
a third-stage frame;
a plurality of panel holes;
said first-stage frame comprises a top section, a longitudinal section, and a bottom section;
each of the plurality of one-touch-actuated latches comprises a male portion and a female portion;
said left gas-spring strut and said right gas-spring strut each comprise a piston end and a cylinder end;
said at least one left scissor mechanism and said at least one right scissor mechanism each comprise a first rod, a second rod, a first longitudinal track, and a second longitudinal track;
said third-stage frame comprises a left collapsible angle and a right collapsible angle;
said first rod and said second rod each comprise a translational pivot point, a central pivot point, and a fixed pivot point;
said left collapsible angle and said right collapsible angle each comprise a bar-shaped leg, a channel-shaped leg, a hinge, a stopper, a hanging prop, and a notch;
said top section being positioned parallel to said bottom section;
said longitudinal section being positioned in between said top section and said bottom section;
said longitudinal section being positioned perpendicular to both said top section and said bottom section;
said longitudinal section of said first-stage frame and said longitudinal section of said second-stage frame being aligned with each other;
both said at least one left scissor mechanism and said at least one right scissor mechanism being positioned in between said first-stage frame and said second-stage frame;
said at least one left scissor mechanism and said at least one right scissor mechanism being positioned opposite to each other;
said left gas-spring strut being positioned adjacent to said at least one left scissor mechanism opposite to said at least one right scissor mechanism;
said right gas-spring strut being positioned adjacent to said at least one right scissor mechanism opposite to said at least one left scissor mechanism;
said third-stage frame being positioned adjacent to said second-stage frame opposite to said first-stage frame; and
said left collapsible angle and said right collapsible angle being positioned opposite to each other across said second stage frame.

13. The three-stage display panel mount as claimed in claim 12 comprises,
said male portion of each of said plurality of one-touch-actuated latches being positioned along said longitudinal section of said first-stage frame;
said female portion of each of said plurality of one-touch-actuated latches being positioned along said longitudinal section of said second-stage frame;
said female portion of each of the said plurality of one-touch-actuated latches being aligned with said male portion of each of the plurality of one-touch-actuated latches;
said fixed pivot point of said first rod being rotatably connected to said top section of said first-stage frame;
said fixed pivot point of said second rod being rotatably connected to said top section of second-stage frame;
said first longitudinal track being positioned adjacent to said bottom section of said first-stage frame;
said second longitudinal track being positioned adjacent to said bottom section of said second-stage frame;
said translational pivot point of said first rod being engaged to said second longitudinal track;
said translation pivot point of said second rod being engaged to said first longitudinal track;
said central pivot point of said first rod being rotatably connected to said central pivot point of said second rod;
said fixed pivot point and said translational pivot point for said first rod being positioned opposite each other along said first rod;
said fixed pivot point and said translational pivot point for said second rod being positioned opposite each other along said second rod;
said central pivot point for said first rod being positioned in between said fixed pivot point and said translation pivot point along said first rod; and
said central pivot point for said second rod being positioned in between said fixed pivot point and said translation pivot point along said second rod.

14. The three-stage display panel mount as claimed in claim 12 comprises,
said cylinder end and said piston end for said left gas-spring strut being positioned opposite to each other along said left gas-spring strut;
said cylinder end of said left gas-spring strut being rotatably connected to said top section of said first-stage frame;
said piston end of said left gas-spring strut being rotatably connected to said bottom section of said second-stage frame;
said cylinder end and said piston end for said right gas-spring strut being positioned opposite to each other along said right gas-spring strut;
said cylinder end of said right gas-spring strut being rotatably connected to said top section of said first-stage frame;
said piston end of said right gas-spring strut being rotatably connected bottom section of said second-stage frame;
said plurality of wall holes being positioned on said first-stage frame; and
said plurality of panel holes being positioned on both said channel-shaped leg of said left collapsible angle and said channel-shaped leg of said right collapsible angle.

15. The three-stage display panel mount as claimed in claim 12 comprises,
said bar-shaped leg being connected on said second-stage frame;
said bar-shaped leg being pivotally connected to said channel-shaped leg by said hinge;
said stopper being connected perpendicular to said bar-shaped leg;
said stopper and said hinge being positioned opposite to each other along said bar-shaped leg;
said securing tab being connected perpendicular to said channel-shaped leg;
said securing tab and said hinge being positioned opposite to each other along said channel-shaped leg;
said notch being positioned in between said stopper and said hinge and traversing into said bar-shaped leg; and
said hanging prop being rotatably connected to said channel-shaped leg.

16. The three-stage display panel mount as claimed in claim 15 comprises,
said notch being engaged by said hanging prop in order to perpendicularly position said channel-shaped leg to said bar-shaped leg.

17. The three-stage display panel mount as claimed in claim 15 comprises,
said channel-shaped leg being pressed against said stopper in order to position said channel-shaped leg parallel to said bar-shaped leg;
said bar-shaped leg traversing into said channel-shaped leg in order to position said channel-shaped leg parallel to said bar-shaped leg; and
said securing tab being adjacently pressed against said bar-shaped leg in order to position said channel-shaped leg parallel to said bar-shaped leg.
